(19) United States
(12) Patent Application Publication
(10) Pub. No.: US 2026/0312345 A1
(43) Pub. Date: Oct. 8, 2026

(54) COAXIAL CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yasunori ASANO, Mie (JP); Yutaka KOBAYASHI, Mie (JP)

(21) Appl. No.: 19/482,781

(22) PCT Filed: Apr. 30, 2024
(86) PCT No.: PCT/JP2024/016659

§ 371 Date: Nov. 10, 2025

(30) Foreign Application Priority Data
May 16, 2023 (JP) 2023-080615

(51) Int. Cl. H01R 24/40; H01R 103/00

(52) U.S. Cl. CPC H01R 24/40; H01R 2103/00

(57) ABSTRACT

The purpose of the present invention is to enable the position at which a center conductor penetrates a dielectric to be restricted while suppressing any effect on communication performance. This coaxial connector includes a center conductor, a dielectric surrounding the center conductor, and a cylindrical outer conductor surrounding the dielectric. The center conductor includes an elongated center conductor body, and a protrusion protruding at an intermediate position in the longitudinal direction of the center conductor body. The dielectric has a through-hole through which the center conductor body can penetrate. The protrusion partially protrudes in the circumferential direction of the center conductor body, and the center conductor body penetrates the through-hole in a state in which the protrusion is in contact with one of the two axial ends of the dielectric.

### TECHNICAL FIELD

The present disclosure relates to a coaxial connector.

### BACKGROUND

Patent Document 1 discloses a connector provided with a second center conductor, a second holding member and a second outer conductor. The second center conductor extends long in an axial direction through the second holding member. A protrusion is formed in a part in the axial direction of the second center conductor. The protrusion is in contact with an end surface of the second holding member.

### PRIOR ART DOCUMENT

### Patent Document

Patent Document 1: JP 2016-039001 A

### SUMMARY OF THE INVENTION

### Problems to be Solved

The protrusion of the second center conductor in Patent Document 1 is thought to function to restrict the penetration position of the second center conductor with respect to the second holding member. If a thick part is partially provided in an intermediate part in a longitudinal direction of a center conductor, it is thought to affect the communication performance of a coaxial connector.

Accordingly, the present disclosure aims to enable the penetration position of a center conductor with respect to a dielectric to be restricted while suppressing an influence on communication performance.

### Means to Solve the Problem

The present disclosure is directed to a coaxial connector with a center conductor, a dielectric surrounding the center conductor, and a tubular outer conductor surrounding the dielectric, the center conductor including a center conductor body formed into an elongated shape and a protrusion projecting at an intermediate position in a longitudinal direction of the center conductor body, the dielectric including a through hole, the center conductor body being passable through the through hole, the protrusion partially projecting in a circumferential direction of the center conductor body, and the center conductor body being passed through the through hole with the protrusion held in contact with one of both end parts in an axial direction of the dielectric.

Effect of the Invention According to the present disclosure, the penetration position of a center conductor with respect to a dielectric can be restricted while an influence on communication performance is suppressed.

### BRIEF DESCRIPTION OF THE DRAWINGS

FIG. 1 is a perspective view showing a device provided with an external connection coaxial connector according to an embodiment.

FIG. 2 is a section along II-II of FIG. 1.

FIG. 3 is a perspective view showing the external connection coaxial connector.

FIG. 4 is a back view showing the external connection coaxial connector.

FIG. 5 is an exploded perspective view showing the external connection coaxial connector.

FIG. 6 is a section along VI-VI of FIG. 4.

### DETAILED DESCRIPTION TO EXECUTE THE INVENTION

### Description of Embodiments of Present Disclosure

First, embodiments of the present disclosure are listed and described.

The coaxial connector of the present disclosure is as follows.

(1) The coaxial connector of the present disclosure is provided with a center conductor, a dielectric surrounding the center conductor, and a tubular outer conductor surrounding the dielectric, the center conductor including a center conductor body formed into an elongated shape and a protrusion projecting at an intermediate position in a longitudinal direction of the center conductor body, the dielectric including a through hole, the center conductor body being passable through the through hole, the protrusion partially projecting in a circumferential direction of the center conductor body, and the center conductor body being passed through the through hole with the protrusion held in contact with one of both end parts in an axial direction of the dielectric.

According to this coaxial connector, the penetration position of the center conductor with respect to the dielectric is restricted by the contact of the protrusion with the one end part of the dielectric. Further, the communication performance of the coaxial connector is assumed to be designed based on an outer diameter of the center conductor body and an inner diameter of the outer conductor. Since the protrusion only partially projects in the circumferential direction of the center conductor body, it hardly affects the communication performance of the coaxial connector designed, assuming the outer diameter of the center conductor body. Thus, the penetration position of the center conductor with respect to the dielectric can be restricted while an influence on the communication performance is suppressed.

(2) In the coaxial connector of (1), a dimension from a center axis of the center conductor body to a projecting end of the protrusion may be larger than a radius of the through hole.

In this way, the protrusion can more reliably contact the one end part of the dielectric, and the penetration position of the center conductor with respect to the dielectric is more reliably restricted.

(3) In the coaxial connector of (1) or (2), a recess partially recessed in a circumferential direction of the dielectric may be formed on an inner peripheral side of the one end part of the dielectric, and the protrusion may be in contact with a bottom of the recess.

In this case, since at least a part of the protrusion enters the recess and the protrusion is in contact with the bottom of the recess, a volume occupied by the dielectric around the protrusion can be increased. In this way, the communication performance is improved.

(4) In the coaxial connector of (3), a length of the recess may be larger than that of the protrusion in a circumferential direction of the through hole.

In this case, since the length of the recess is larger than that of the protrusion in the circumferential direction of the through hole, the protrusion is easily arranged in the recess.

(5) In the coaxial connector of (3) or (4), an annular tapered surface for guiding the center conductor into the through hole may be formed on the inner peripheral side of the one end part of the dielectric, the recess may be formed in a circumferential part of the annular tapered surface, and the protrusion may be in contact with the bottom of the recess in a state where at least a part of the protrusion is present in a formation range of the annular tapered surface in a direction of a center axis of the through hole.

In this case, since the protrusion is in contact with the bottom of the recess with at least a part of the protrusion overlapping the formation range of the annular tapered surface in the direction of the center axis of the through hole, a depth of the recess is easily reduced (shallowed). In this way, a volume occupied by the dielectric around the center conductor can be increased, and the communication performance is improved.

(6) In the coaxial connector of any one of (1) to (5), the center conductor may include a retaining protrusion separated from the protrusion at an intermediate position in the longitudinal direction of the center conductor body, the retaining protrusion may be so shaped that a height is gradually reduced toward a side opposite to the protrusion, and the retaining protrusion may be locked to an inner peripheral part of the through hole to retain the center conductor body with respect to the dielectric in the axial direction with the protrusion held in contact with the one end part of the dielectric.

In this way, the center conductor can be prevented from coming out from the dielectric in a state where the protrusion is held in contact with the one end part of the dielectric and the penetration position of the center conductor is restricted.

(7) In the coaxial connector of any one of (1) to (6), the center conductor may include only one protrusion.

Only one protrusion is less likely to affect the communication performance of the coaxial connector. Thus, the penetration position of the center conductor with respect to the dielectric can be restricted while an influence on the communication performance is suppressed.

### Details of Embodiment of Present Disclosure

A specific example of a coaxial connector of the present disclosure is described below with reference to the drawings. Note that the present disclosure is not limited to these illustrations, but is represented by claims and intended to include all changes in the scope of claims and in the meaning and scope of equivalents.

### Embodiment

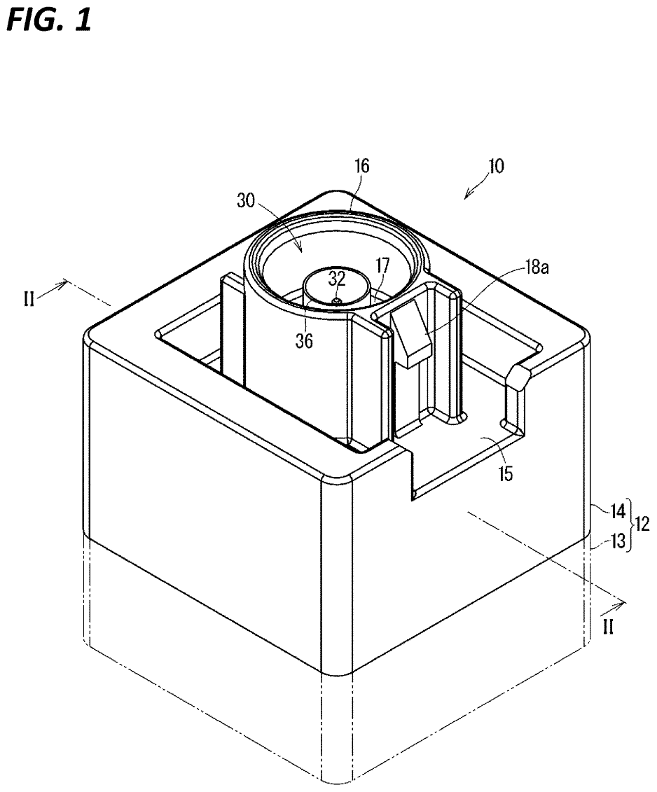

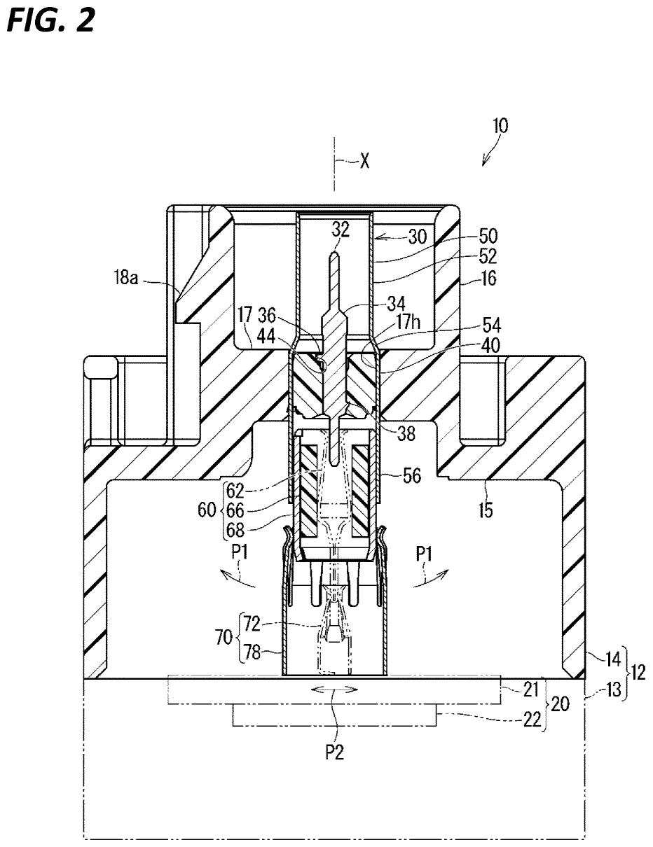

Hereinafter, a coaxial connector according to an embodiment is described. FIG. 1 is a perspective view showing a device 10 provided with an external connection coaxial connector 30 as the coaxial connector. FIG. 2 is a section along II-II of FIG. 1.

### Concerning Overall Configuration of Device

The device 10 is, for example, a camera device. The camera device is, for example, an in-vehicle device. The device 10 may not be a camera device.

The device 10 is provided with a case 12 and a mounting board 20. The mounting board 20 is accommodated in the case 12. A board side coaxial connector 70 is fixed to the mounting board 20.

The case 12 is provided with a first case 13 and a second case 14. The first and second cases 13, 14 are, for example, made of resin. By uniting the first and second cases 13, 14, the case 12 in the form of a rectangular parallelepiped box for accommodating the mounting board 20 is configured. If the device 10 is a camera device, it is assumed that the first case 13 includes a lens or window for imaging, and the second case 14 includes the external connection coaxial connector 30.

The external connection coaxial connector 30 is a coaxial connector for connecting the mounting board 20 and an external electrical component. For example, the external connection coaxial connector 30 is a coaxial connector, to which a cable connected to the external electrical component is connected. The cable connected to the external connection coaxial connector 30 is, for example, a coaxial cable.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a direction of a center axis X of the holding tube portion 16. In this embodiment, the holding/partitioning portion 17 is formed in the intermediate part in the direction of the center axis X of the holding tube portion 16 and at a position near the inner opening. The holding/partitioning portion 17 partitions between a space on the inner opening side and a space on the outer opening side in the holding tube portion 16. The holding/partitioning portion 17 is formed with a holding hole 17h, and the external connection coaxial connector 30 is inserted and held in the holding hole 17h.

In this embodiment, a locking protrusion 18a for holding a cable connector mounted on an end part of the cable is formed on an outer peripheral part of the holding tube portion 16. It is not essential to form the locking protrusion 18a.

The external connection coaxial connector 30 is provided with an external connection center conductor 32, an external connection dielectric 40 and an external connection outer conductor 50.

The external connection center conductor 32 is in the form of an elongated bar and made of an electrically conductive material such as metal. The external connection center conductor 32 is an example of a center conductor. The external connection dielectric 40 is formed of an insulator such as resin and surrounds the external connection center conductor 32. In this embodiment, the external connection dielectric 40 is an example of a dielectric surrounding the external connection center conductor 32. The external connection outer conductor 50 is made of an electrically conductive material such as metal. The external connection outer conductor 50 is an example of a tubular outer conductor surrounding the external connection dielectric 40.

The external connection coaxial connector 30 is connected to a relay coaxial connector 60 from a side opposite to the board side coaxial connector 70.

The mounting board 20 includes, for example, a circuit board 21 formed with a circuit by a copper foil or the like. An electronic component may be mounted on the circuit board 21. If the device 10 is a camera device, the mounting board 20 is assumed to include the circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

In this embodiment, the board side coaxial connector 70 is located on a surface of the circuit board 21 opposite to the imaging element 22. The board side coaxial connector 70 is fixed to the circuit board 21 by soldering or the like and projects from the circuit board 21 toward the external connection coaxial connector 30. The board side coaxial connector 70 is, for example, provided with a board side center conductor 72 and a board side outer conductor 78. Each of the board side center conductor 72 and the board side outer conductor 78 is fixed to the circuit board 21 by soldering or the like and projects from this circuit board 21. A movable side center conductor 62 to be described later is connected to the board side center conductor 72. The board side outer conductor 78 surrounds the board side center conductor 72 while being spaced apart therefrom. A movable side outer conductor 68 to be described later is connected to the board side outer conductor 78. The board side outer conductor 78 is an example of a mating terminal to be connected to the movable side outer conductor 68 as an example of a terminal. The board side coaxial connector 70 may be provided with a dielectric interposed between the board side center conductor 72 and the outer conductor.

The board-side coaxial connector 70 is connected to the relay coaxial connector 60 from a side opposite to the external connection coaxial connector 30.

The board side coaxial connector 70 and the external connection coaxial connector 30 are connected via the relay coaxial connector 60. The relay coaxial connector 60 is, for example, provided with the movable side center conductor 62, a movable side dielectric 66 and the movable side outer conductor 68.

The movable side outer conductor 68 is made of an electrically conductive material such as metal. The movable side outer conductor 68 is formed into a tubular shape as a whole. The movable side outer conductor 68 is connected to the board side outer conductor 78.

The movable side center conductor 62 is formed of an electrically conductive material such as metal into an elongated shape. The movable side center conductor 62 is arranged coaxially with the movable side outer conductor 68.

The movable side dielectric 66 surrounds the movable side center conductor 62. A dielectric can be grasped as one type of an insulator. The movable side outer conductor 68 surrounds the movable side dielectric 66. The movable side dielectric 66 is an example of a dielectric interposed between the movable side outer conductor 68 and the movable side outer conductor 68.

The relay coaxial connector 60 is connected to the board side coaxial connector 70 in a state where the movable side center conductor 62 is inserted and connected to the board side center conductor 72 and the movable side outer conductor 68 is externally fit and connected to the board side outer conductor 78. In this state, the relay coaxial connector 60 projects further toward the external connection coaxial connector 30 from the board side coaxial connector 70. The external connection center conductor 32 is inserted and connected to the movable side center conductor 62 and the movable side outer conductor 68 is inserted and connected to the external connection outer conductor 50, whereby the relay coaxial connector 60 is connected to the external connection coaxial connector 30.

In this way, by connecting a cable from outside to the external connection coaxial connector 30, an external electrical component as a connection destination of this cable and the mounting board 20 in the case 12 are electrically connected.

In a connected state of the relay coaxial connector 60 and the board side coaxial connector 70, the movable side center conductor 62 can be inserted and connected in an inclined state to the board side center conductor 72. Further, the movable side outer conductor 68 can be inserted and connected in an inclined state to the board side outer conductor 78. That is, the relay coaxial connector 60 can be connected in an inclined state to the board side coaxial connector 70 (see arrows P1 of FIG. 2). In this way, even if the board side coaxial connector 70 and the external connection coaxial connector 30 deviate from positions facing each other on the same axis during an assembly operation of this device 10 or in a completed state of this device 10 (see arrows P2 of FIG. 2), the relay coaxial connector 60 is inclined with respect to the board side coaxial connector 70, whereby these position deviations are absorbed.

### Concerning External Connection Coaxial Connector

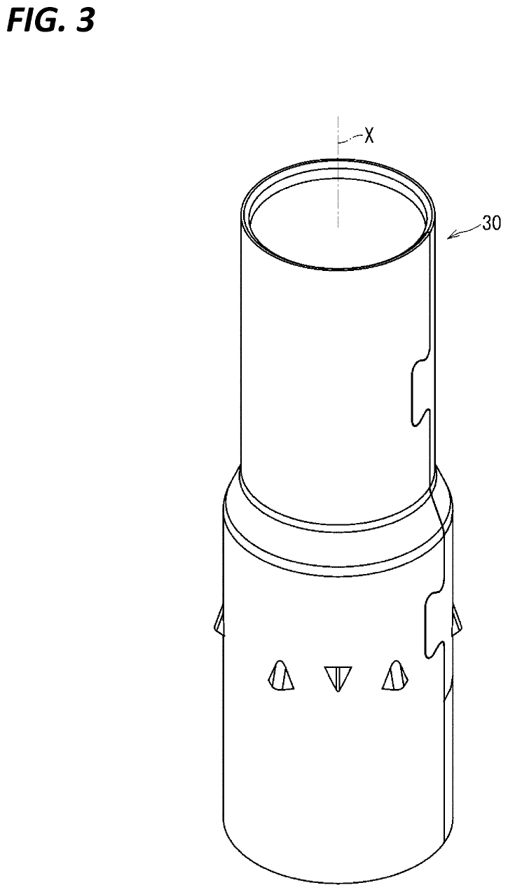

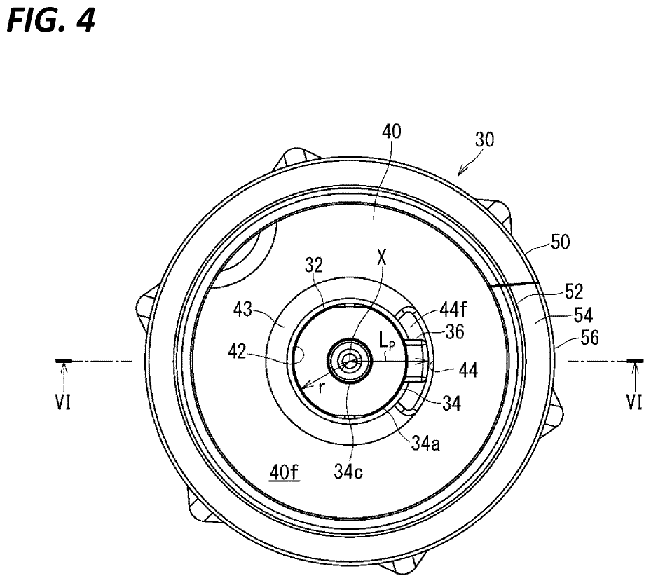

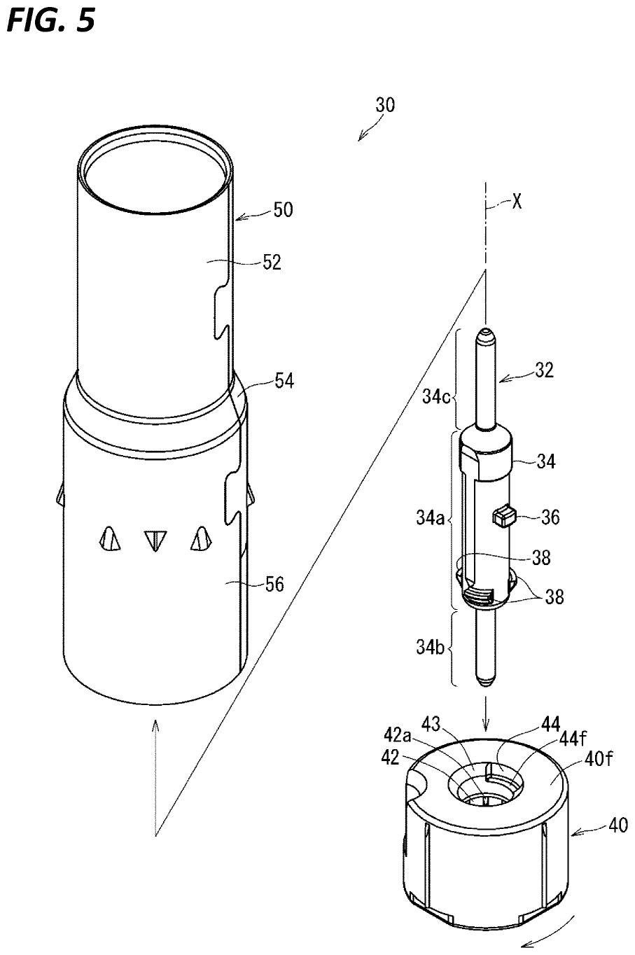

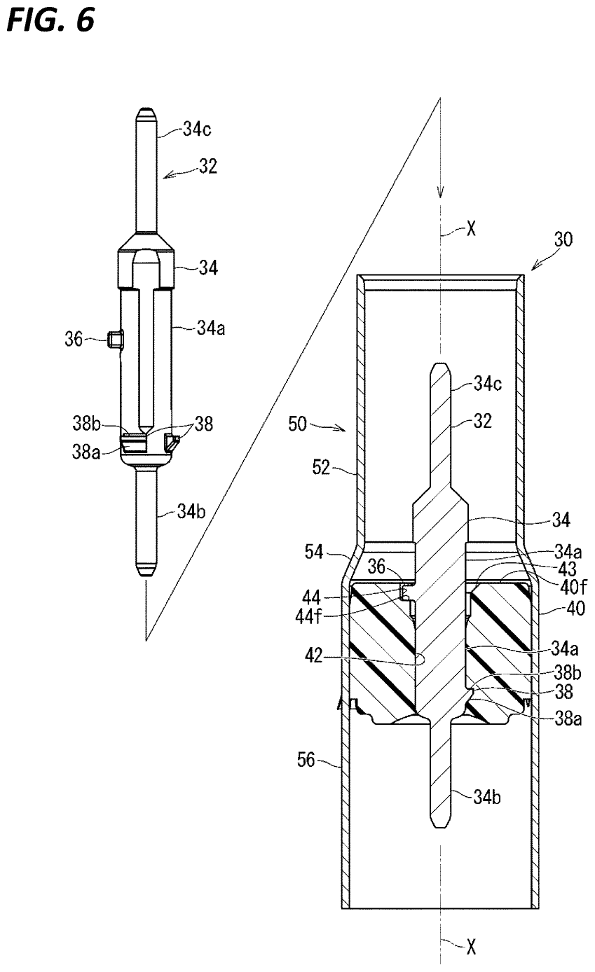

The external connection coaxial connector 30 is more specifically described. FIG. 3 is a perspective view showing the external connection coaxial connector 30. FIG. 4 is a back view showing the external connection coaxial connector 30. FIG. 5 is an exploded perspective view showing the external connection coaxial connector 30. FIG. 6 is a section along VI-VI of FIG. 4. The external connection center conductor 32 before insertion is shown in FIG. 6.

The configuration of each component of the external connection coaxial connector 30 is more specifically described.

The external connection center conductor 32 is formed into an elongated shape as a whole. The external connection center conductor 32 may be, for example, formed by cutting metal or by press-working a metal plate.

The external connection center conductor 32 includes a center conductor body 34 and a protrusion 36.

The center conductor body 34 is in the form of a round bar. In this embodiment, the center conductor body 34 includes an intermediate trunk portion 34a, a first connecting end portion 34b and a second connecting end portion 34c.

The intermediate trunk portion 34a is in the form of a round bar located between the first and second connecting end portions 34b, 34c. The intermediate trunk portion 34a is thicker than both the first and second connecting end portions 34b, 34c. At least a part of the intermediate trunk portion 34a is held through the external connection dielectric 40.

The intermediate trunk portion 34a may include a partial planar part, a dent or a recess. The planar part, dent or recess may be shaped not to restrict the rotational posture of the intermediate trunk portion 34a with respect to the external connection dielectric 40.

The first connecting end portion 34b extends further to a tip side from one end part of the intermediate trunk portion 34a, and the second connecting end portion 34c extends further to a tip side from the other end part of the intermediate trunk portion 34a. The first and second connecting end portions 34b, 34c are in the form of round bars thinner than the intermediate trunk portion 34a. The first connecting end portion 34b is a part to be connected to the relay coaxial connector 60 in the case 12, and the second connecting end portion 34c is a part to be connected to the cable outside the case 12. Note that an intermediate trunk portion, a first connecting end portion and a second connecting end portion may have the same thickness.

The protrusion 36 is a part partially projecting at an intermediate position in a longitudinal direction of the center conductor body 34. The protrusion 36 partially projects also in a circumferential direction of the center conductor body 34.

In this embodiment, the protrusion 36 is formed in an intermediate part in the longitudinal direction of the intermediate trunk portion 34a, more specifically at a position closer to the second connecting end portion 34c than a center position in the longitudinal direction of the intermediate trunk portion 34a.

A dimension of the protrusion 36 in the longitudinal direction of the center conductor body 34, a dimension of the protrusion 36 in the circumferential direction of the center conductor body 34 and a projecting dimension of the protrusion 36 from the outer peripheral surface of the center conductor body 34 are arbitrary. Each of those dimensions is preferably set to be able to exhibit strength sufficient to receive an insertion force when the external connection center conductor 32 is inserted into the external connection dielectric 40. Further, each of those dimensions is preferably set such that the protrusion 36 does not scrape the external connection dielectric 40 when the external connection center conductor 32 is inserted into the external connection dielectric 40. Since the insertion force possibly varies due to the capability, setting and the like of an assembly device, each of the above dimensions may be set according to an insertion force of the assembly device.

Further, if the protrusion 36 is too large, it largely affects a distance (inter-conductor distance) between the external connection center conductor 32 and the external connection outer conductor 50. Thus, preferably, each dimension of the protrusion 36 is preferably as small as possible while satisfying constraints of each dimension.

For example, the base end of the protrusion 36 may extend in a range of 30° to 60° about the center axis X of the center conductor body 34. The tip surface of the protrusion 36 may be a surface arcuately extending about the center axis X of the center conductor body 34. Note that the external connection coaxial connector 30 is formed into a coaxial shape, and a center axis X of a through hole 42 coincides with the center axis of each of the external connection coaxial connector 30, the external connection center conductor 32, the external connection dielectric 40 and the external connection outer conductor 50.

In this embodiment, the external connection center conductor 32 includes only one protrusion 36. The external connection center conductor 32 may include a plurality of protrusions at intervals in the circumferential direction.

The external connection center conductor 32 includes retaining protrusions 38 located away from the protrusion 36 at an intermediate position in the longitudinal direction of the center conductor body 34. In this embodiment, the external connection center conductor 32 includes a plurality of (here, three) retaining protrusions 38 at intervals in the circumferential direction of the center conductor body 34. The number of the retaining protrusions 38 is arbitrary and may be one. The retaining protrusions may also be omitted. In this case, a thickness of the center conductor body 34 may be set such that the center conductor body 34 is press-fit into the external connection dielectric 40.

The retaining protrusions 38 are formed at positions near the first connection end part 34b in the intermediate trunk portion 34a. The retaining protrusion 38 is shaped such that a height is gradually reduced toward an opposite side.

More specifically, the retaining protrusion 38 has a slope 38a and a retaining surface 38b.

The slope 38b is a surface having a gradually increasing projecting dimension from the outer peripheral surface of the intermediate trunk portion 34a toward the protrusion 36. The slope 38a may be an arcuate slope corresponding to the outer peripheral surface of the intermediate trunk portion 34a. The slope may be a flat surface.

The retaining surface 38b is a surface facing toward the protrusion 36, out of the retaining protrusion 38. The retaining surface 38b may be a surface orthogonal to the center axis X of the center conductor body 34.

A projecting dimension of the retaining protrusion 38 from the center axis X of the center conductor body 34 is preferably smaller than that of the protrusion 36 from the center axis X. In this way, the retaining protrusions 38 can be press-fit into the external connection dielectric 40 and excessive penetration is easily suppressed by the protrusion 36.

The external connection dielectric 40 is a dielectric made of resin or the like. The external connection dielectric 40 is, for example, a molded resin component. The external connection dielectric 40 is formed into a cylindrical shape. A length of the external connection dielectric 40 is shorter than that of the external connection center conductor 32 and, in this embodiment, shorter than that of the intermediate trunk portion 34a.

The through hole 42 is formed along the center axis X in a center of the external connection dielectric 40. The through hole 42 is a hole, through which the center conductor body 34 can be passed. The through hole 42 may be a hole larger than an outer diameter of the intermediate trunk portion 34a or may be a hole, into which the intermediate trunk portion 34a can be press-fit.

An elongated protrusion 42a (see FIG. 5) along the center axis X may be formed on the inner peripheral surface of the through hole 42. A plurality of the elongated protrusions 42a may be formed at intervals in the circumferential direction of the through hole 42. The rotation of the external connection center conductor 32 is suppressed by the elongated protrusion 42a when the external connection center conductor 32 is passed through the through hole 42.

The external connection center conductor 32 is held in a state passed through the through hole 42 with both end parts of the external connection center conductor 32 projecting. In this embodiment, a part near the first connection end part 34b, out of the intermediate trunk portion 34a of the external connection center conductor 32, is accommodated in the through hole 42. A part near the second connection end part 34c, out of the intermediate trunk portion 34a, and the second connection end part 34c project outward from one end part of the external connection dielectric 40. The first connection end part 34b projects outward from the other end part of the external connection dielectric 40.

In the above state, the protrusion 36 is in contact with the other end part of the external connection dielectric 40. In this way, the external connection center conductor 32 is restricted from coming out toward the first connection end part 34b from the external connection dielectric 40.

Further, in the above state, the retaining protrusions 38 are retained and locked to an inner peripheral part of the through hole 42. That is, the external connection center conductor 32 can be pushed into the through hole 42 by pressing the slopes 38a of the retaining protrusions 38 into contact with the inner peripheral part of the through hole 42. The retaining protrusions 38 remain in the through hole 42 with the external connection center conductor 32 passed through until the protrusion 36 contacts the one end part of the external connection dielectric 40. In this state, tip parts of the retaining surfaces 38b are hooked to the inner peripheral part of the through hole 42 with the retaining surfaces 38b of the retaining protrusions 38 facing toward the protrusion 36. In this way, the external connection center conductor 32 is suppressed from coming out toward the protrusion 36.

That is, with the protrusion 36 held in contact with the one end part of the external connection dielectric 40, the external connection center conductor 32 is suppressed from coming out toward the second connection end part 34c by the contact of the protrusion 36 with the one end part of the external connection dielectric 40, and the external connection center conductor 32 is suppressed from coming out toward the second connection end part 34c by the retaining surfaces 38b being retained and locked to the inner peripheral part of the through hole 42. In this way, the external connection center conductor 32 is accurately held in a state passed through the external connection dielectric 40 at a fixed position.

In the above state, the entire protrusion 36 can be observed when viewed from one side of the external connection dielectric 40. It is assumed that, when viewed from the other side of the external connection dielectric 40, the retaining protrusions 38 are not observed at all or only base end parts thereof are observed.

A dimension Lp from the center axis X of the center conductor body 34 to the projecting end of the protrusion 36 is preferably larger than a radius r of the through hole 42. In this way, the protrusion 36 can more reliably contact the one end part of the external connection dielectric 40.

A recess 44 partially recessed in the circumferential direction of the external connection dielectric 40 may be formed on an inner peripheral side of the one end part of the external connection dielectric 40. The recess 44 may be formed into an arcuate recess extending along the circumferential direction of the through hole 42.

The recess 44 is formed in a partial region, where the protrusion 36 can be arranged, on the inner peripheral side of the one end part of the external connection dielectric 40. For example, an annular tapered surface 43 for guiding the external connection center conductor 32 into the through hole 42 is formed on the inner peripheral side of the one end part of the external connection dielectric 40. The annular tapered surface 43 is also a tapered surface for making one opening of the through hole 42 gradually larger. An annular end surface 40f located on one end of the external connection dielectric 40 spreads on an outer peripheral side of the annular tapered surface 43. The annular end surface 40f extends in a direction orthogonal to the center axis X. The recess 44 may be located in a formation range of the annular tapered surface 43 in the direction along the center axis X.

Since the recess 44 is partially recessed in the circumferential direction of the external connection dielectric 40, the annular tapered surface 43 is formed in the other part.

At least a part of the protrusion 36 enters the recess 44 and contacts a bottom 44f of the recess 44. In this way, the external connection center conductor 32 is restricted from moving toward the first connecting end portion 34b with respect to the external connection dielectric 40.

By the entrance of at least a part of the protrusion 36 into the recess 44, a protruding amount of the protrusion 36 from the one end part of the external connection dielectric 40 can be reduced. In this way, a component of a connection target connector becomes less likely to interfere with the protrusion 36 and, for example, a dielectric of the connection target connector is easily arranged near the external connection dielectric 40.

Note that a protrusion may contact one end surface of an external connection dielectric not formed with the recess.

An arc length L1 of the recess 44 is preferably larger than an arc length L2 of the protrusion 36 in the circumferential direction of the through hole 42. That is, the center conductor body 34 and the external connection dielectric 40 have a shape close to a rotating body shape and the protrusion 36 is small enough not to largely affect communication performance. Thus, in terms of the communication performance, the rotational posture of the external connection center conductor 32 with respect to the external connection dielectric 40 may be thought not to be particularly limited. However, if the recess 44 is entirely formed in the circumferential direction of the through hole 42, a volume of the dielectric present between the inner and outer conductors is reduced and an influence on the communication performance is possibly increased.

On the other hand, if the recess 44 is so sized that the protrusion 36 is just fit thereinto, it is thought that it becomes difficult to align the position of the protrusion 36 with that of the recess 44, the external connection center conductor 32 cannot be passed at a predetermined position or the recess 44 is partially scraped when the external connection center conductor 32 is passed through the external connection dielectric 40. Accordingly, the arc length L1 of the recess 44 is made larger than the arc length L2 of the protrusion 36 while the recess 44 is formed in a partial range in the circumferential direction of the through hole 42. In this way, the protrusion 36 can be easily arranged in the recess 44 while the volume of the dielectric present between the inner and outer conductors is increased.

The arc length L1 of the recess 44 may be set to be larger than the arc length L2 of the protrusion 36, considering a deviation tolerance in a rotation direction possibly occurring during insertion by an assembly machine for the external connection coaxial connector 30. For example, the arc length L1 of the recess 44 may be within a range of two to four times as large as the arc length L2 of the protrusion 36.

A depth of the recess 44 is arbitrary, but may be a depth enough for the entire protrusion 36 to be inserted in the recess 44. In this way, the protrusion 36 hardly projects from the annular end surface 40f and interference with other components is suppressed.

If the recess 44 is too deep in the direction of the center axis X, the volume of the dielectric present between the inner and outer conductors is reduced and the communication performance is possibly affected. From this point, the recess 44 is preferably as shallow as possible.

As described above, the recess 44 is formed in a circumferential part of the annular tapered surface 43. For example, the protrusion 36 may be configured to be able to contact the bottom 44f of the recess 44 with at least a part of the protrusion 36 overlapping the formation range of the annular tapered surface 43 in the direction of the center axis X of the through hole 42. In this way, the recess 44 can be formed near the one end part of the external connection dielectric 40, and a space where the dielectric is absent can be maximally reduced.

The external connection outer conductor 50 is made of metal or the like. For example, the external connection outer conductor 50 may be formed by deep drawing a metal material, may be formed by press-working a metal plate or may be formed by cutting.

The external connection outer conductor 50 has a hollow cylindrical shape. A length of the external connection outer conductor 50 is larger than that of the external connection dielectric 40. The external connection dielectric 40 is located in the middle of the external connection outer conductor 50 in an extension direction. Both ends of the external connection center conductor 32 may be located in the external connection outer conductor 50.

In this embodiment, the external connection outer conductor 50 includes a small-diameter portion 52, a large-diameter portion 56 larger than the small-diameter portion 52 and a gradual changing portion 54 having a diameter gradually increased between the small-diameter portion 52 and the large-diameter portion 56. The large-diameter portion 56 is a part facing the inside of the case 12, and the small-diameter portion 52 is a part facing the outside of the case 12. The large-diameter portion 56 has an diameter corresponding to a thickness of the movable side outer conductor 68, which is a connection destination in the case 12, and the small-diameter portion 52 has a diameter corresponding to a thickness of the connector on the cable end part outside the case 12. The large-diameter portion 56 of the external connection outer conductor 50 is press-fit and held in the holding hole 17h. In accordance with the thicknesses of the connectors as the connection destinations, a thickness relationship of both ends of an external connection outer conductor may be opposite to the above one or the external connection outer conductor may have a tubular shape having a uniform diameter. The gradual changing portion 54 is formed into a tapered shape having a diameter gradually increased from the small-diameter portion 52 to the large-diameter portion 56.

The external connection dielectric 40 is set to have such a thickness as to be insertable into the large-diameter portion 56. For example, an outer diameter of the external connection dielectric 40 is equal to an inner diameter of the large-diameter portion 56 and larger than an inner diameter of the small-diameter portion 52. The external connection dielectric 40 is press-fit into the external connection outer conductor 50 through an opening on the side of the large-diameter portion 56. The external connection dielectric 40 is located adjacent to the gradual changing portion 54 in the large-diameter portion 56. For example, an end surface facing toward the small-diameter portion 52, out of the external connection dielectric 40, is located on a boundary between the gradual changing portion 54 and the large-diameter portion 56.

By arranging the external connection dielectric 40 in the external connection outer conductor 50 as described above, the large-diameter portion 56 and the first connecting end portion 34b are facing the inside of the case 12 and connected to the relay coaxial connector 60. Further, the small-diameter portion 52 and the second connecting end portion 34c are facing the outside of the case 12 and connected to the cable side connector.

### Effects, Etc.

According to the external connection coaxial connector 30 configured as described above, the penetration position of the external connection center conductor 32 with respect to the external connection dielectric 40 is restricted by the contact of the protrusion 36 with the one end part of the dielectric 40. Further, the communication performance of the external connection coaxial connector 30 is assumed to be designed based on an outer diameter of the external connection center conductor 32 and an inner diameter of the external connection outer conductor 50. Since the protrusion 36 partially projects in the circumferential direction of the center conductor body 34, the protrusion 36 hardly affects the communication performance of the external connection coaxial connector 30 designed, assuming the outer diameter of the center conductor body 34. Therefore, the penetration position of the external connection center conductor 32 with respect to the external connection dielectric 40 can be restricted while an influence on the communication performance is suppressed.

Particularly, if the external connection center conductor 32 includes only one protrusion 36, this only one protrusion 36 is less likely to affect the communication performance.

Further, the protrusion 36 partially projecting in the circumferential direction of the center conductor body 34 can be easily formed also by press-working a metal plate. Thus, as described above, the configuration relating to the center conductor including the center conductor body and the protrusion partially projecting in the circumferential direction has a merit of being easily applicable to the center conductor formed by press-working a metal plate.

Further, the projecting dimension Lp of the protrusion 36 from the center axis X of the external connection center conductor 32 is larger than the radius r of the through hole 42. Thus, it is difficult to insert the protrusion 36 into the through hole 42 and the protrusion 36 can more reliably contact the one end part of the external connection dielectric 40. In this way, the penetration position of the external connection center conductor 32 with respect to the external connection dielectric 40 is more reliably restricted.

Further, the external connection dielectric 40 is formed with the recess 44, and the protrusion 36 is in contact with the bottom 44f of the recess 44. Thus, at least a part of the protrusion 36 can enter the recess 44 and contact the bottom 44f of the recess 44. Thus, a volume occupied by the dielectric around the protrusion 36 can be increased. In this way, the communication performance is improved.

Further, the arc length L1 of the recess 44 is larger than the arc length L2 of the protrusion 36 in the circumferential direction of the through hole 42. Thus, when the external connection center conductor 32 is inserted into the through hole 42, the protrusion 36 is easily arranged in the recess 44. In this way, the protrusion 36 is easily positioned by being brought into contact with the bottom 44f of the recess 44, and the position of the external connection center conductor 32 with respect to the external connection dielectric 40 in a penetration direction is stabilized.

Further, the protrusion 36 is in contact with the bottom 44f of the recess 44 with at least a part of the protrusion 36 overlapping the formation range of the annular tapered surface 43 in the direction of the center axis X of the through hole 42. Thus, the recess 44 is easily made shallow. In this way, a volume occupied by the dielectric around the external connection center conductor 32 can be increased, and the communication performance is improved.

Further, the external connection center conductor 32 includes the retaining protrusions 38 and the retaining protrusions 38 are retained and locked to the inner peripheral part of the through hole 42 with the protrusion 36 held in contact with the one end part of the external connection dielectric 40. Thus, the external connection center conductor 32 is easily held at the fixed position in the state arranged to pass through the external connection dielectric 40.

Note that the configuration for restricting the penetration position of the external connection center conductor 32 with respect to the external connection dielectric 40 utilizing the protrusion 36 may be applied to a body side coaxial connector, a relay coaxial connector or a connector for coaxial cable.

Note that the respective configurations described in the above embodiment and each modification can be approximately combined without contradicting each other.

### LIST OF REFERENCE NUMERALS

10 device
12 case
13 first case
14 second case
15 bottom portion
16 holding tube portion
17 holding/partitioning portion
17h holding hole
18a locking protrusion
20 mounting board
21 circuit board
22 imaging element
30 external connection coaxial connector (coaxial connector)
32 external connection center conductor (center conductor)
34 center conductor body
34a intermediate trunk portion
34b first connecting end portion
34csecond connecting end portion
36 protrusion
38 retaining protrusion
38a slope
38b retaining surface
40 external connection dielectric (dielectric)
40f annular end surface
42 through hole
42a elongated protrusion
43 annular tapered surface
44 recess
44f bottom of recess
50 external connection outer conductor (outer conductor)
52 small-diameter portion
54 gradual changing portion
56 large-diameter portion
60 relay coaxial connector
62 movable side center conductor
66 movable side dielectric
68 movable side outer conductor
70 body side coaxial connector
72 body side center conductor
78 body side outer conductor
Lp dimension of projecting end of protrusion
X center axis
r radius of through hole

1. A coaxial connector, comprising:
a center conductor;
a dielectric surrounding the center conductor; and
a tubular outer conductor surrounding the dielectric,
the center conductor including a center conductor body formed into an elongated shape and a protrusion projecting at an intermediate position in a longitudinal direction of the center conductor body,
the dielectric including a through hole, the center conductor body being passable through the through hole,
the protrusion partially projecting in a circumferential direction of the center conductor body, and
the center conductor body being passed through the through hole with the protrusion held in contact with one of both end parts in an axial direction of the dielectric.

2. The coaxial connector of claim 1, wherein a dimension from a center axis of the center conductor body to a projecting end of the protrusion is larger than a radius of the through hole.

3. The coaxial connector of claim 1, wherein:
a recess partially recessed in a circumferential direction of the dielectric is formed on an inner peripheral side of the one end part of the dielectric, and
the protrusion is in contact with a bottom of the recess.

4. The coaxial connector of claim 3, wherein a length of the recess is larger than that of the protrusion in a circumferential direction of the through hole.

5. The coaxial connector of claim 3, wherein:
an annular tapered surface for guiding the center conductor into the through hole is formed on the inner peripheral side of the one end part of the dielectric,
the recess is formed in a circumferential part of the annular tapered surface, and
the protrusion is in contact with the bottom of the recess in a state where at least a part of the protrusion is present in a formation range of the annular tapered surface in a direction of a center axis of the through hole.

6. The coaxial connector of claim 1, wherein:
the center conductor includes a retaining protrusion separated from the protrusion at an intermediate position in the longitudinal direction of the center conductor body,
the retaining protrusion is so shaped that a height is gradually reduced toward a side opposite to the protrusion, and
the retaining protrusion is locked to an inner peripheral part of the through hole to retain the center conductor body with respect to the dielectric in the axial direction with the protrusion held in contact with the one end part of the dielectric.

7. The coaxial connector of claim 1, wherein the center conductor includes only one protrusion.
